(19) United States
(12) Patent Application Publication
(10) Pub. No.: US 2010/0215883 A1
(43) Pub. Date: Aug. 26, 2010

(54) Composite Material with Silicone Coat

(76) Inventors: Jia-Chang Yang, Taipei County (TW); Ming-Huei Hsu, Taipei County (TW)

Correspondence Address: SHOU - HSIN YIN, P.O. BOX 90-3 Taipei, TAIPEI City, 10699, TW

(21) Appl. No.: 12/393,078

(22) Filed: Feb. 26, 2009

(51) Int. Cl. B32B 33/00; B32B 9/04; B32B 5/00

(52) U.S. Cl. 428/41.8; 428/447; 428/195.1

(57) ABSTRACT

A composite material having a coat layer made of silicone is disclosed. The composite material includes a substrate and a silicone layer thereon. The composite material not only is innocent to human bodies and environment, but also has superior and various properties.

### BACKGROUND OF THE INVENTION

1. Technical Field

The invention relates an artificially synthetic material, more particularly to a material analogous to genuine leather, which is used as coats, covers or embellishments.

2. Related Arts

With development of technologies, artificially composite materials are applied extensively. For example, polyurethane (PU) and polyvinyl chloride (PVC) materials are frequently adopted to be as a leatherlike coat material of bags, purses, suitcases, shoes, leather coats and leather chairs, or as ornamental or sheathing exterior material of wallpaper, toys, etc. Additionally, the PU and PVC materials also can be fabric of umbrellas, raincoats, sports gloves, tablecloths and window shades. Those chemically synthetic materials have satisfied requirements of markets and enriched people's lives.

However, with development of society, some chemical materials have been superseded because the environment protection is highly esteemed in recent years. The PVC material, for example, has been banned from using because of its defects. Therefore, most of the synthetic leathers are made of the PU material. However, its breathable, temperature-resistant, durable, waterproof ability and haptic sense are not good enough. Hence, an artificially synthetic coat material having various superior properties is required by the markets.

### SUMMARY OF THE INVENTION

An object of the present invention is to provide a composite material with silicone coat, which is innocent to human bodies and environment and has superior and various properties.

To accomplish the above object, the invention provides a composite material including a substrate and a silicone layer thereon.

### BRIEF DESCRIPTION OF THE DRAWINGS

FIG. 1 is a sectional view of a preferred embodiment according to the invention; and

FIG. 2 is a sectional view of another preferred embodiment according to the invention.

### DETAILED DESCRIPTION OF THE INVENTION

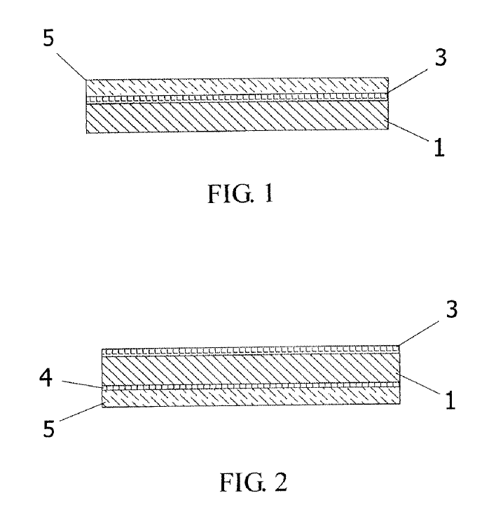

Referring to FIG. 1, a preferred embodiment according to the invention is shown. The composite material with silicone coat is composed of a layer of substrate and a layer of silicone. Transparent or translucent liquid silicone made by a process using platinum as a catalyst is spread on a transitional release layer 5. The release layer 5 can be veined or glossy. By heating, the liquid silicone gradually becomes a filmlike silicone layer 3. Then, a substrate 1 is adhered on the silicone layer 3. A finished product is obtained when the release layer 5 is removed out of the silicone layer 3. An outer surface of the silicone layer 3 is veined if the release layer 5 is veined. Of course, the outer surface of the silicone layer 3 also can be made glossy or mat. Additionally, the outer surface of the silicone layer 3 can be printed or etched a pattern or text. The substrate 1 is made of any one of chemical fiber, glass fiber, cotton, gunny, paper or metal. The composite material of the invention can be cut or sewed as general cloth. In this preferred embodiment, the liquid silicone can be mixed with coloring if required, so that the silicone layer 3 can appear in desired color.

FIG. 2 shows another preferred embodiment according to the invention, which has the same essential structure as the abovementioned embodiment. The difference between the two embodiments is that a pressure sensitive adhesive layer 4 is additionally attached on the substrate 1. A release layer 5 is attached on the pressure sensitive adhesive layer 4. The composite material can be directly used when the release layer 5 is removed. It is very convenient for users. The release layer 5 can be a release paper or film.

The composite material with silicone coat according to the invention is innocent and has superior various properties to existing products, such as temperature-enduring ability, durability, electro-insulatability and chemical resistivity. An outer surface of the composite material with silicone coat is soft with great tactual sense, and further has functions of waterproof, slide-proof and thermo-isolation. It can be extensively applied in many fields. The composite material of the invention can be cut or sewed just as general cloth. The composite material also can be directly used when the release layer 5 is removed.

What is claimed is:

1. A composite material comprising:
a substrate made of soft material; and
a silicone layer attached on the substrate.

2. The composite material of claim 1, further comprising a pressure sensitive adhesive layer attached on the substrate and a release layer attached on an outer side of the pressure sensitive adhesive layer.

3. The composite material of claim 2, wherein the release layer is a release paper or film.

4. The composite material of claim 1, wherein the silicone layer is formed from a transparent or translucent liquid silicone made by a process using platinum as a catalyst.

5. The composite material of claim 2, wherein the silicone layer is formed from a transparent or translucent liquid silicone made by a process using platinum as a catalyst.

6. The composite material of claim 1, wherein the silicone layer is mixed with coloring.

7. The composite material of claim 1, wherein the substrate is made of one of chemical fiber, glass fiber, cotton, gunny, paper or metal.

8. The composite material of claim 1, wherein an outer surface of the silicone layer is etchedly veined, glossy or matt.

9. The composite material of claim 1, wherein an outer surface of the silicone layer is printed or etched a pattern or text.
